(19) United States
(12) Patent Application Publication
(10) Pub. No.: US 2003/0192751 A1
(43) Pub. Date: Oct. 16, 2003

(54) Tractor trailer air brakes

(76) Inventor: Jack Costa, Mississauga (CA)

Correspondence Address: Elias C. Borges, Suite 406, 1 Eva Road, Toronto, ON, M9C 4Z5, CA

(21) Appl. No.: 10/429,770

(22) Filed: May 6, 2003

Related U.S. Application Data
(63) Continuation-in-part of application No. 10/106,126, filed on Mar. 22, 2002.

(51) Int. Cl. F16D 65/24

(52) U.S. Cl. 188/170

(57) ABSTRACT

The present invention is a fast acting pneumatic brake system for vehicles. The system includes an pneumatic spring brake operatively coupled to a first and second air tank via supply and constant pressure air lines, respectively. A pneumatically controlled central air valve is operatively coupled to the supply air line. The central air valve is operatively coupled to a hand valve which controls the operation of the central valve. A first electrically controlled air valve is operatively coupled to the supply air line between the pneumatic spring brake and the pneumatically controlled air valve. The first electrically controlled valve is a normally open valve which closes only when energized. A second electrically controlled air valve is operatively coupled to the constant pressure air line between the pneumatic spring brake and the second air tank. The second electrically controlled air valve is a normally closed valve which opens only when energized. The system includes a control circuit for simultaneously energizing the first and second electrically controlled air valves.

### CROSS REFERENCE TO RELATED APPLICATION

This is a continuation-in-part application of application Ser. No. 10/106,126 filed Mar. 22, 2002, the entirety of which is incorporated herein by reference.

### FIELD OF THE INVENTION

The invention relates generally to the field of tractor trailer pneumatic spring brakes.

### BACKGROUND OF THE INVENTION

Jack-knifing of tractor trailers is a serious problem. Jack-knifing occurs when the truck portion of a tractor trailer is forced out of alignment with the trailer, usually as a result of hard breaking. Generally speaking, jack-knifing occurs when the truck portion of the tractor trailer begins to slow down rapidly compared to the trailer portion. The momentum of the trailer portion forces the truck out of alignment with the trailer. When jack-knifing occurs, the truck operator effectively loses control of the vehicle and an accident may result. Unfortunately, jack-knifing is most likely to occur in emergency situations when the truck brakes are applied forcefully.

Existing tractor trailer brakes are not designed to effectively prevent jack-knifing. Existing tractor trailer brakes consist of a series of pneumatically operated brakes operatively coupled to the rear wheels of the trailer. These pneumatically operated brakes are in turn operatively coupled to an air supply located in the truck via a pneumatic line. A trailer brake control valve in the truck controls the flow of air to the pneumatic brakes in the trailer, and is used to either engage or release the brakes as desired. When the operator engages the brake hand valve, pneumatic pressure travels down the pneumatic line to the pneumatic brakes causing the brakes to engage. Since the pneumatic brakes are some distance from the trailer brake control valve, there is a time delay between the activation of the trailer brake control valve and the engaging of the trailer brakes. Since the brakes in the truck portion of the tractor trailer are closer to the brake control systems than the brakes of the trailer portion are to the trailer brake control valve, the truck brakes will engage before the rear trailer brakes. In a majority of cases, this time delay is not significant; however, in emergency situations, under conditions of hard braking, this time delay may be sufficient to cause jack-knifing. Brake control systems on the market today do not address the time lag between the engaging of truck brakes and rear trailer brakes; therefore, the problem of jack-knifing tractor trailers continues.

### SUMMARY OF THE INVENTION

The present invention is an improved pneumatic brake system for vehicles. The system includes an pneumatic spring brake operatively coupled to a first and second air tank via service and constant pressure air lines, respectively. A pneumatically controlled central air valve is operatively coupled to the service air line. The central air valve is operatively coupled to a hand valve which controls the operation of the central valve. A first electrically controlled air valve is operatively coupled to the service air line between the pneumatic spring brake and the pneumatically controlled air valve. The first electrically controlled valve is a normally open valve which closes only when energized. A second electrically controlled air valve is operatively coupled to the constant pressure air line between the pneumatic spring brake and the second air tank. The second electrically controlled air valve is a normally closed valve which opens only when energized. Finally, the system includes a control circuit for simultaneously energizing the first and second electrically controlled air valves.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a cross sectional view of a typical trailer pneumatic spring brake.

FIG. 2. is a schematic view of a pneumatic brake system made in accordance with the present invention.

FIG. 3 is a schematic representation of the electronic control circuit of the present invention.

In the drawings like characters of reference indicate corresponding parts in the different figures.

### DETAILED DESCRIPTION OF THE INVENTION

Before discussing the detailed operation of the present invention, an explanation of standard brakes as used on a majority of trailers must first be discussed. A majority of trailers presently on the road have a conventional friction brake operatively coupled to each trailer wheel. The friction brake, hereafter referred to as the trailer brake, is in turn operatively coupled to a pneumatic (or air) brake. The pneumatic spring brake is a pneumatically operated device which uses a flow of high pressure air from the tractor to operate the trailer brake. The present invention utilizes a majority of the features of existing pneumatic brake systems.

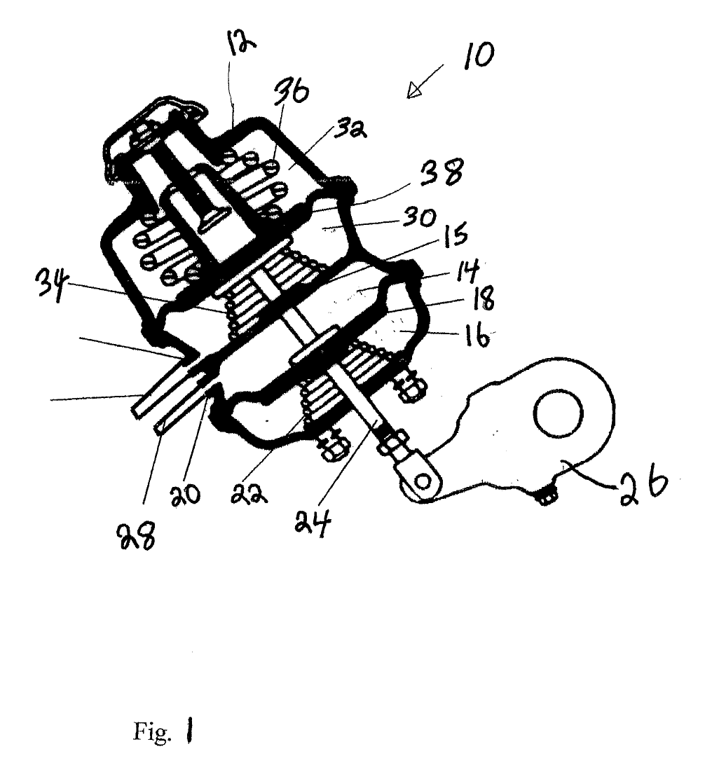

Referring to FIG. 1, a standard pneumatic brake is shown generally as item 10 and consists of a housing 12 having separate chambers 14 and 30. Chamber 14, which is commonly referred to as the service chamber, is an airtight chamber having a rigid wall 15, a flexible diaphragm 18 and port 20. Chamber 16 is generally not airtight and has spring 22 which is positioned to bias diaphragm 18 towards rigid wall 15. Spring 22 applies sufficient biasing force against diaphragm 18 to press the diaphragm against rigid wall 15 provided the air pressure in chamber 14 is not pressurized. Pressurizing service chamber 14 to beyond about 60 psi causes diaphragm 18 to move away from rigid wall 15 and towards chamber 16. Connecting rod 24 physically connects diaphragm 18 to friction break 26, such that when diaphragm 18 moves away from rigid wall 15, the rod forces the friction break 26 to engage and when diaphragm moves towards rigid wall 15, the friction break will release. Port 20 is coupled to air line 28. The air pressure in chamber 14 is controlled by air pressure supplied through air line 28.

In addition to chambers 14 and 16, spring 22, and diaphragm 18 pneumatic spring brake 10 may have additional chamber 32, springs 34 and 36 and flexible diaphragm 38. These additional features are generally included in order to provide a parking brake feature. Not all pneumatic brakes have these parking brake features, but all pneumatic brakes will have service chamber 14, chamber 30, and flexible diaphragm 18.

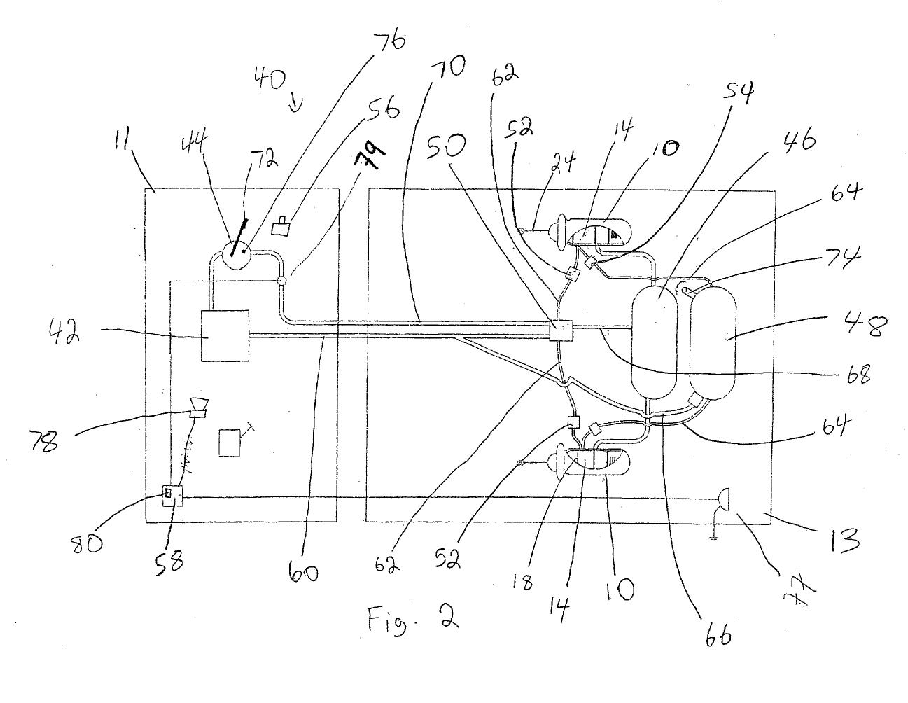

Referring now to FIG. 2, the pneumatic braking system of the present invention, shown generally as item 40, consists of an air compressor 42, a hand valve 44, a first air tank 46, a second air tank 48, a central valve 50, a first electrically operated valve 52, a second electrically operated valve 54, an electronic brake button 56, an electronic control circuit 58 and pneumatic lines 60, 62, 64, 66, 68 and 70. Air compressor 42 is a standard air compressor as found on any truck that is equipped with pneumatic spring brakes. Air tank 48, referred to as the secondary air tank or second air tank, is directly supplied with air pressure from air compressor 42 via lines 60 and 66 and has exhaust valve 74 which keeps the air pressure within air tank 48 at 120 psi. Air tank 46, referred to as the service air tank, is supplied with air pressure from compressor 42 via air lines 60 and 68. Air tank 46 also has an exhaust valve (not shown) which keeps the pressure in the air tank to a maximum of 120 psi.

Service chamber 14 of pneumatic spring brake 10 is supplied with air pressure through air lines 62 and 64. Since the pressure in air line 62 is controlled by central valve 50 (as will be explained later), and supplies the air pressure to operate the brake during normal operation, air line 62 may be referred to as the service line. Electrically operated valve 52 is placed in pneumatic line 62. Valve 52 is a normally open valve, preferably a solenoid valve, which normally permits air pressure to flow through line 62 until the valve is energized. When energized, valve 52 closes off air line 62. Airline 62 is coupled to central valve 50, which is in turn coupled to air lines 70 and 68. Central valve 50 is a pneumatically controlled air valve which controls the flow of air from air tank 46 to spring brake 10. Central valve 50 may be a standard pneumatically controlled air valve as found on a majority of pneumatic trailer brake systems. Central valve 50 is selectively controlled by air pressure supplied by service line 70. Service line 70 is coupled to air compressor 42 and the amount of pressure in air line 70 is controlled by hand valve 44. The amount of air flowing through valve 44 may be selectively controlled simply by moving lever 72 between a fully opened and a fully closed position. Therefore, the operation of central valve 50 is controlled by hand valve 44. When hand valve 44 is closed, air pressure is decreased in air line 70 which in turn causes central valve 50 to open permitting air pressure from line 62 to exhaust to atmosphere, releasing the break. When hand valve 44 is opened, air pressure is increased in air line 70 which in turn causes central valve 50 to change position permitting more air pressure from line 68 to flow through line 62 to pneumatic spring brake 10 causing the pneumatic spring brake to engage. Therefore, the amount of braking force applied by pneumatic spring brakes 10 is selectively controlled by hand valve 44 by moving lever 72 of the hand valve. Hand valve 44 includes an electrical contact 76, which is closed only when lever 72 is moved all the way into its fully opened position. Contact 76 is operatively coupled to electronic control circuit 58. Electronic control circuit 58 is adapted to trigger signal 78 when contact 76 is closed. Signal 78 may be a buzzer or light (or a combination of both) located in cab 11 of the truck.

Air tank 48 is pneumatically coupled to service chamber 14 of pneumatic spring brake 10 via pneumatic line 64. Since the air pressure in air tank 48 is substantially constant at 120 psi, pneumatic line 64 may be referred to as a constant pressure line. Electrically controlled valve 54 is placed in line 64 to control the flow of air from tank 48 to service chamber 14. Electrically controlled valve 54 is a normally closed valve which only opens when energized. Electrically controlled valve 54 is preferably a solenoid valve. When valve 54 is energized, the valve is opened and air flows from tank 48 to service chamber 14 causing pneumatic spring brake 10 to engage almost immediately. Both electrically controlled valves 52 and 54 are operatively coupled to electronic control circuit 58. Electronic control circuit 58 is configured to simultaneously energize electrically controlled valves 52 and 54 only when contact 76 is closed and button 56 is depressed.

The operation of the system will now be explained with reference to FIG. 2. When the driver in cab 13 wishes to stop the vehicle quickly, he or she will engage lever 72 of hand valve 44 and move it all the way into its open position. When lever 72 is all the way into its open position, contact 76 is closed and signal 78 is triggered. The triggering of signal 78 indicates to the driver that the fast brake feature is now available for activation. If the driver wishes to activate the fast brake feature, the driver simply presses button 56 to close it. When button 56 is then closed, control circuit 58 then energizes electric control valves 52 and 54. Valve 52 then closes and valve 54 opens. With valve 54 open, air flows from tank 48 into service chamber 14 of pneumatic spring brake 10 causing the pneumatic spring brake to almost immediately engage. It will be appreciated that since tank 48 is held at a constant 120 psi, the pneumatic spring brake will engage quickly. With the pneumatic spring brakes engaged, trailer 13 begins to slow down and eventually stop. Valve 52 is closed when energized, thereby preventing air from flowing from exhausting from chamber 14.

The present system has the advantage of being quick acting. Using the present system, the driver can activate the pneumatic spring brakes much quicker simply by depressing a button when the hand valve is in its fully closed position. The signal (pilot light or buzzer) acts to remind the driver that this quick braking feature is available.

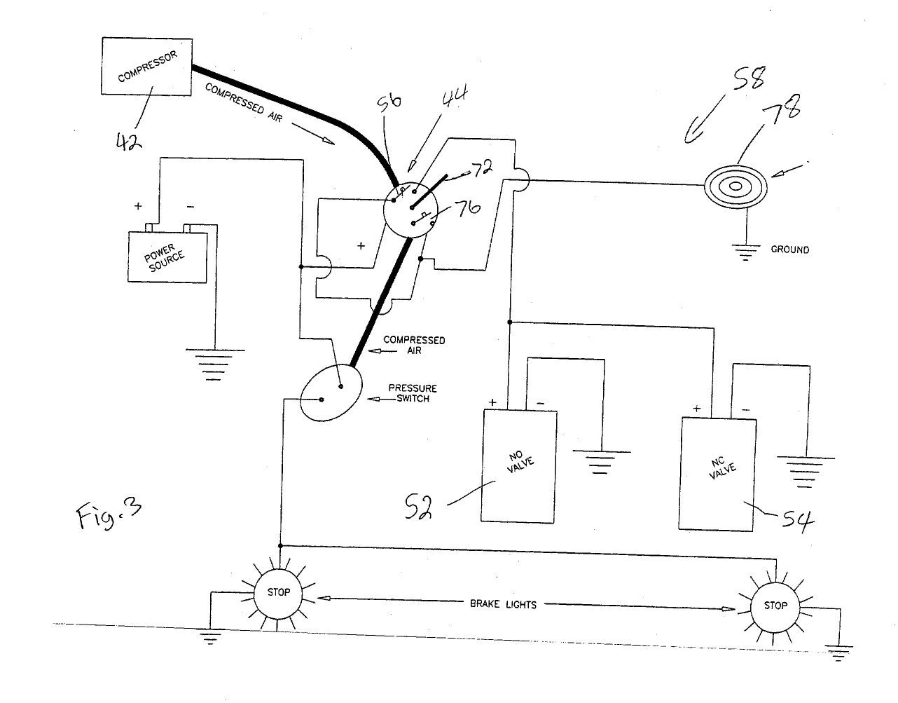

Control circuit 58 is shown schematically in FIG. 3. For easy of design, contact 76 and button 56 may be in series such that both must be closed for the circuit to be completed and valves 52 and 54 to be energized.

The quick acting break system is disengaged simply by the operator moving the hand valve back towards its closed position. When the operator moves lever 72 into its closed position, contact 76 is opened, the buzzer shuts off and the two electronically controlled valves 52 and 54 are de-energized. This returns the brake system back to its normally operating state. If the operator continues to move lever 72 fully into its closed position, then air pressure is decreased in air line 70 which in turn causes central valve 50 to open permitting air pressure from line 62 to exhaust to atmosphere, releasing the brake.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A pneumatic brake system comprising;
a an pneumatic spring brake,
b a first air tank operatively coupled to the pneumatic spring brake by a supply air line,
c a pneumatically controlled valve operatively coupled to the supply air line, the pneumatically controlled air valve being controlled by a hand valve,
d a first electrically controlled air valve operatively coupled to the supply air line between the pneumatic spring brake and the pneumatically controlled air valve, the first electrically controlled valve being a normally open valve which closes only when energized,
e a second air tank operatively coupled to the pneumatic spring brake by a constant pressure air line,
f a second electrically controlled air valve operatively coupled to the constant pressure air line between the pneumatic spring brake and the second air tank, the second electrically controlled air valve being a normally closed valve which opens only when energized,
g a control circuit for simultaneously energizing the first and second electrically controlled air valves.

2. The system of claim 1 wherein hand valve includes an electrical contact which is activated only when the hand valve is in a fully opened position, the control circuit being operatively coupled to the electrical contact such that the control circuit can only energize the valves when the electrical contact is activated, the control circuit being configured to de-energize the valves when the electrical contact is de-activated.

3. The system as defined in claim 2 further comprising a signal operatively coupled to the electrical contact and a control button operatively coupled to the control circuit, the control circuit configured to alarm the signal only when the electrical contact is activated, the control circuit further configured to energize the valves only when both the control button and electrical contact are activated.
